(19) United States
(12) Patent Application Publication
(10) Pub. No.: US 2018/0143677 A1
(43) Pub. Date: May 24, 2018

(54) STANDBY POWER CONTROLLER COMMUNICATIONS AND VERIFICATION APPARATUS AND METHOD

(71) Applicant: Embertec Pty Ltd, Dulwich, South Australia (AU)

(72) Inventor: Domenico Gelonese, Dulwich, South Australia (AU)

(73) Assignee: EMBERTEC PTY LTD, Dulwich (AU)

(21) Appl. No.: 15/564,339

(22) PCT Filed: Mar. 10, 2016
(86) PCT No.: PCT/AU2016/000078

§ 371 Date: Oct. 4, 2017

(30) Foreign Application Priority Data
Mar. 11, 2015 (AU) 2015900869

(51) Int. Cl. G06F 1/32; G08C 17/02; H04L 12/12; H04Q 9/02

(52) U.S. Cl. CPC G06F 1/325; G06F 1/3287; G06F 1/3209; G08C 23/04; G08C 17/02; H04L 12/12; H04Q 9/02; G06F 1/3218

(57) ABSTRACT

A standby power controller of a type including a power sensor which senses power drawn through the standby power controller and a processor which/uses the power sensor to determine that devices connected to the standby power controller are in a low power standby power sate, and a remote control use sensor to determine that a television connected to the standby power controller is in an active standby mode. The standby power controller operates a switch to remove power from connected devices when either standby mode is determined. There is a remote data link providing data communication between the standby power controller and a remote monitoring entity. The standby power controller may include' a simulation mode. When said simulation mode is active, the setting of the switch state value does not cause operation of the switch.

### TECHNICAL FIELD

This invention relates to a standby power controller having data communication capability including a verification and monitoring capability.

### BACKGROUND OF THE INVENTION

The following references to and descriptions of prior proposals or products are not intended to be and are not to be construed as statements or admissions of common general knowledge in the art. In particular, the following prior art discussion does not relate to what is commonly or well known by the person skilled in the art, but may assist in the understanding of the inventive step of the present invention, of which the identification of pertinent prior proposals is but one part.

There is currently world-wide concern about the level of use of electrical energy for both domestic and commercial uses. In part this concern is based on the greenhouse gas production associated with the generation of electrical energy, and the contribution of that greenhouse gas to anthropogenic global warming. There is also a concern for the capital cost involved in building the electricity generating plants and electricity distribution networks required to generate and distribute an increasing amount of electricity.

A significant contributor to the energy use of households is the audio visual equipment including multiple devices such as televisions, television decoders, television recorders and sound equipment now found in virtually all homes.

Efforts have been made to reduce or control the use of energy by television receivers and associated audio visual equipment, in particular with the use of standby power controllers, and these have met with considerable success. Attempts have been made to add improved functionality to the basic standby power controller to improve power saving and also to enhance user experience. User experience is important. One of the greatest barriers to power saving by standby power controllers is user uptake and continued use. Features which address these problems often require user interaction or more sophisticated controls.

Installation of standby power controllers has often been incentivised by energy utilities or government agencies. These bodies seek assurances that the anticipated energy savings from such installations are actually achieved and are achieved on an ongoing basis. These bodies wish to be assured that additional features which increase the cost of installed devices do lead to greater savings or better retention rates.

### DISCLOSURE OF THE INVENTION

Accordingly, in a first aspect this invention there is provided a standby power controller of a type including a power sensor which senses power drawn through the standby power controller (SPC). There is a processor which analyses the output of said power sensor to determine that devices connected to the standby power controller are in a low power standby power state and a remote control use sensor to sense use of a remote control device. The processor analyses the output of the remote control use sensor to determine that a television connected to the standby power controller is in an active standby mode. The processor sets a switch state flag to a value of ON or OFF which will cause the operation of a switch which is adapted to operate to remove power from said television when said active standby or low power standby state is determined. There is a remote data link providing data communication between the SPC and a remote monitoring entity.

In preference, the processor receives the output of the power sensor and communicates the output of the power sensor to the monitoring entity.

In preference, the processor receives the output of the remote control use sensor, the processor processing said output to determine that a remote control device has been operated and communicates the result of the determination to the monitoring entity.

In preference, the processor receives the output of the remote control use sensor and communicates the output of the remote control use sensor to the monitoring entity.

In preference, the processor communicates the switch state to the monitoring entity.

In preference, the standby power controller includes a simulation mode. When the simulation mode is active, the setting of the switch state value does not cause operation of the switch.

In preference, simulation mode may be made active by a command from the monitoring entity, or operation of a switch integrated into the standby power controller.

There is a display and processing device in wireless communication with the standby power controller, which provides a user interface able to control at least one function of the standby power controller.

In preference, the display and processing device is one of a smartphone, a tablet computer, a desktop computer and a dedicated display device.

In preference the user interface allows a user to command the standby power controller to enter simulation mode.

In a further form, the invention may be said to lie in a method for monitoring the operation of a standby power controller including installing a standby power controller in a household; then establishing a remote data link to a monitoring entity. The standby power controller senses power data being the power drawn through the standby power controller by connected devices, and communicates the power data to a remote monitoring entity.

In preference, the power data is analysed to determine that a television to which electric power is provided by the standby power controller is in a low power standby state, and upon such determination being made, power supply is removed from the television. The result of the analysis is communicated to the remote monitoring entity.

In preference, the method includes monitoring for use of a remote control device, and, where use of a remote control device is not detected for a selected time period, the television is determined to be in an active standby state. Power is removed from the television and the determination communicated to the remote monitoring entity.

The invention may further be said to lie in a method for estimating the power savings attributed to an installation of a standby power controller. The standby power controller includes a simulation mode which may be turned on and off. In simulation mode, the standby power controller performs all analysis, communication and sensing functions, but does not operate to remove power from connected devices.

A remote data link is established to a monitoring entity and simulation mode is turned on. The standby power controller senses power data (being the power drawn through the standby power controller by connected devices) and the power data is analysed to determine that a television to which electric power is provided by the standby power controller is in a low power standby state.

This determination is communicated to the remote monitoring entity.

The standby power controller continues to sense power data and to communicate the power data to the remote monitoring entity allowing the remote monitoring entity to determine the energy saving to be attributed to an installation of the standby power controller to be the energy the power data indicates is consumed while the television is in a low power standby state.

In preference the method further includes monitoring for use of a remote control device and where use of a remote control device is not detected for a selected time period, determining that a television to which electric power is provided by the standby power controller is in an active standby state. The determination is communicated to the remote monitoring entity.

The standby power controller will continue to sense power data and to sense remote control use. The power data and the continuing determination that the television is in an active standby state are communicated to the remote monitoring entity, allowing the remote monitoring entity to determine the energy saving to be attributed to an installation of the standby power controller to be the energy the power data indicates is consumed while the television is in a low power standby state and the energy consumed while the television is in an active standby state.

In preference the remote data link is provided in part by a connection from the standby power controller to a smartphone provided by the household.

In preference the remote data link is provided in part by a connection from the standby power controller to an internet router provided by the household.

In a further form there is provided a standby power controller of a type including data communication link with a processing and display device, the processing and display device providing a user interface;

a power sensor adapted to sense power drawn through the standby power controller, means to determine from said power sensor output that devices connected to the standby power controller are in a low power standby power state;
means to determine that a television connected to the standby power controller is in an active standby mode;
switch adapted to operate to remove power from said television when said active standby or low power standby state is determined;
wherein the user interface is adapted to allow a user to command the standby power controller to record the occurrence of said standby mode without operation of the switch.

In preference, the standby power controller is adapted to use the data communication link to communicate the determination of a standby state to the processing ad display device.

### BRIEF DESCRIPTION OF THE DRAWINGS

The invention will now be described with reference to certain non-limiting embodiments in connection with the accompanying drawings in which:

FIG. 1 is a representation of a standby power controller incorporating the invention.

FIG. 2 is a representation of a standby power controller incorporating the invention as used with a set top box.

FIG. 3 is physical block diagram of an embodiment of the invention.

FIG. 4 is physical block diagram of a further embodiment of the invention.

FIG. 5 is a block diagram representation of data flows for an embodiment of the invention.

FIG. 6a is a partial flowchart of an embodiment of the invention.

FIG. 6b is a partial flowchart of an embodiment of the invention.

### DETAILED DESCRIPTION OF THE DRAWINGS

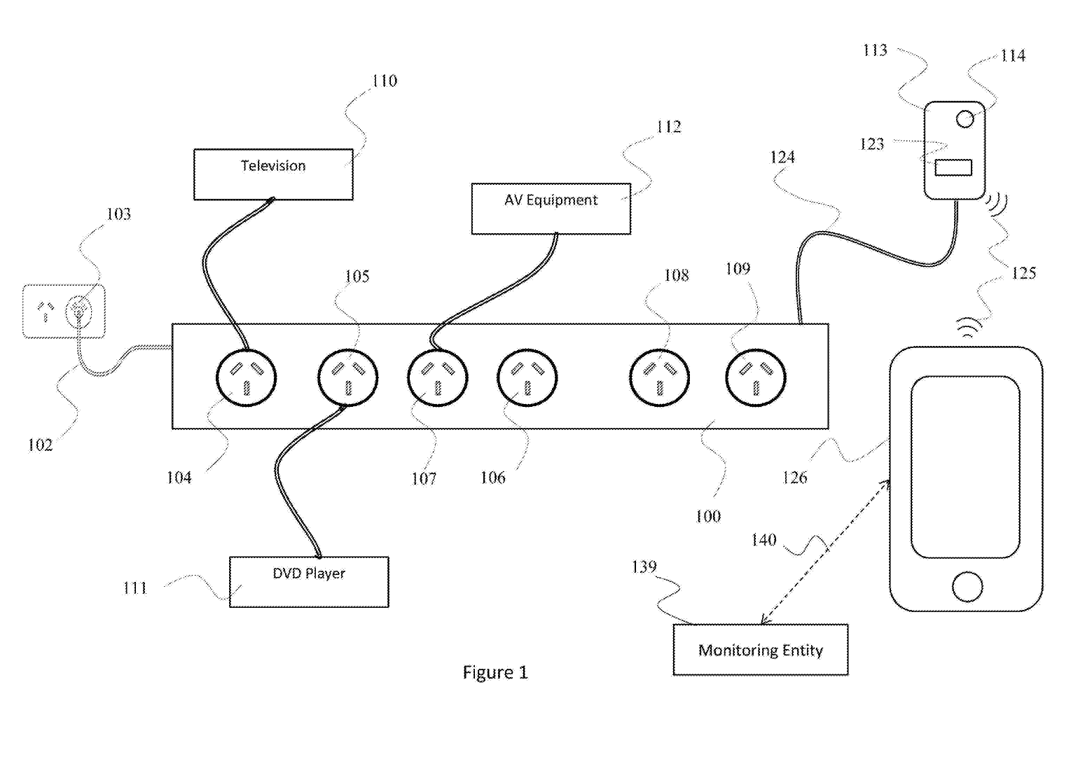

Referring first to FIG. 1, it is to be understood that this is a general representation of an installation including a standby power controller (SPC) including the invention and is illustrative only. It is not intended to limit the number or configuration of continually powered or switched or monitored main outlets, or of communication interfaces or other functional modules.

FIG. 1 shows a representation of an SPC including an embodiment of the current invention. An SPC, which may also be called an Advanced Power Strip (APS) is a device which controls the flow of electrical power to one or more connected appliances such that when one or more, or a particular one, of the connected appliances is in a “standby” state where it is not being used, the electrical power supply to one, all or selected ones of the connected appliances is interrupted.

The SPC 100 receives electrical power from a General Purpose Outlet 103, via power cord 102.

The SPC includes Monitored and Controlled Outlets 104,105,106, 107. The SPC also includes Uncontrolled Outlets 108, 109. In general, any number of Monitored and Controlled outlets and Uncontrolled Outlets may be provided. In an embodiment, the Uncontrolled outlet may be absent.

Monitored and Controlled Outlet 104 supplies electrical power to a television 110. Further Monitored and Controlled Outlets 105, 106 may provide electrical power to other audio-visual equipment, for example a DVD player 11 and audio equipment 112. In an embodiment having only one Monitored and Controlled outlet, multiple devices may be powered from the one outlet using a powerstrip. In any embodiment, multiple devices may be powered from one Monitored and Controlled outlet using a powerstrip.

The SPC includes a Sensing and Communications Unit 113. In a preferred embodiment, this unit is in data communication with the body of the SPC via cable 124, which may also provide power to the Sensing and Communications Unit 113. The Sensing and Communications Unit 113 also includes a remote communication means, in the illustrated embodiment a Bluetooth transceiver 123. The cable 124 may be a fixed connection or may be plug connected at one or both ends. In a further embodiment, the Sensing and Communications Unit may be integrated with the SPC body. In further embodiments, the remote communication means may be provided by any convenient wireless protocol, including without limitation, will, zigbee and RF4CE.

Modern television sets and other audio visual equipment, when turned “off” by the remote control, enter a low power “standby” state, in which energy is still consumed, although at a significantly lower level that when the device is nominally “on”. When the television is in this standby state it is not in use, and the power supply to it may be cut to save energy.

It is also the case that television sets may be left on for extended periods when no user is viewing the screen. This may happen when a user falls asleep in front of the television, or when a user, particularly a child or a teenager, simply leaves the vicinity of the television without turning the television off. This state may be termed “active standby”. In this state the television is not in use, and the power supply to it may be cut to save energy.

The SPC may detect that the television has entered a standby state by any convenient means or combination of means.

In order to save energy the SPC operates to remove the power supply from Monitored and Controlled outlet 104 and hence from the attached television, whenever the television is detected to not be in use.

The SPC may also include a power sensor adapted to sense the power drawn through a Monitored and Controlled outlet. The power sensor detects characteristics of the power flow through the outlet. When the characteristic is such as to indicate that the television is in a standby mode the power to the Monitored and Controlled outlet 104, and hence to the attached television or monitor is interrupted.

The SPC may include any number of Monitored and Controlled outlets, which may be monitored and controlled individually or together.

The SPC may include means to detect that a user is interacting with the audio visual equipment and/or the television. The sensing and communications unit 113 includes an infra-red sensor 114. This sensor 114 receives IR signals from a remote control associated with the television or other connected AV equipment.

It is likely that a user, when actively watching television, will periodically use the remote control to change channels, adjust volume, mute commercials, etc. Thus a remote control signal receiver, such as IR sensor 114 can be used as a usage sensor. If no remote control activity is detected by the IR sensor 114 for a period of time, the assumption may be made that the television is not in use, and the power supply to the Monitored and Controlled outlet 104, and hence to the television, is interrupted. This may be achieved by using a countdown timer which starts from a specific initial value equal to a particular time period, say one hour, and having this countdown time continuously decrement. Each detected use of the remote control will reset the countdown timer to the initial value. When the countdown time reaches zero, there has been no remote control activity for the time period, and the television is assumed to not be in active use and the electricity supply to the Monitored and Controlled outlet 104, and hence to the television, is interrupted.

It may be sufficient to determine that a user is present in the vicinity of the television in order to decide that the television should not be turned off. Any suitable sensor may be used for determining that a user is present and thus that power to the television should not be interrupted. These include, without limitation, passive IR sensors, ultrasonic sensors, cameras, any other passive or active movement sensors, and sound detectors.

Whatever means is used to determine that the television is on, but not in use, it is unlikely to be completely free of false positives, that is, determining that the television is in active standby and not in use when the television is in fact in use. If the television is turned off when a user is still watching a program, the user will be irritated. Repeated occurrences are likely to lead to the power control function of the SPC being bypassed, preventing power savings.

The IR sensor 114 is in the form of an LED. This may be used as a warning LED. When the SPC determines that the television is in active standby, the warning LED will flash to alert any user to the imminent shutdown of the power to the television. In the case where there is a false positive, that is, there is a user watching the television, the user may react to observing the flashing of the warning LED by pressing a key on the remote control. The IR signal from the remote control is detected by the IR sensor 114, and the countdown timer is reset, preventing the power to the television being interrupted.

Other methods for warning of imminent shutdown of power to the television may be used. An audible warning tone may sound.

The SPC may include software allowing control of the warning mechanism. The brightness of the LED may be variable. It may be possible to set times when the warning should take certain forms. For example, an audible warning may be used at certain times of the day, whilst the LED is used at other times. At still further times, no warning at all may be given.

Uncontrolled power outlets 108, 109 are optionally provided to allow for power to be supplied to devices which should not have the power supply cut when the television is not in use. This outlet supplies power at all times when the SPC is plugged in. Any number of uncontrolled outlets may be provided.

Devices other than a television may be connected along with a television to the Monitored and Controlled outlets. In this case, the total load of all devices will be monitored for the characteristics indicating that all devices so connected are in a standby or unused state.

A third type of power outlet (not shown) may be provided. This non-monitored, controlled outlet is not monitored by the power sensor, so the power drawn by any load connected to the outlet does not contribute to the determination that the monitored load is in a standby or unused state. This outlet is controlled. When power is interrupted to the monitored, controlled outlet 108, power is also interrupted to this outlet.

The remote communication means provides a local data link to processing devices external to the SPC. An external device may provide a user interface for the SPC, enabling a user to monitor and/or control some functions of the SPC.

There is provided Bluetooth transceiver 123 which provides local data link 125 to an external display and processing device, in the illustrated embodiment, a smartphone 126. In other embodiments, without limitation, the display and processing device may be a tablet computer or a desktop computer or a dedicated display unit. The local data link 125 may be provided by any convenient protocol, including, without limitation, direct wifl, wifi via an existing router, and via a data connection established using an internet connection.

The smartphone 126 runs a program which provides a user interface for the SPC. This user interface allows a user to control settings of the SPC. Settings may include the countdown time before power is removed when no IR activity is detected. The user interface may also be used to activate and deactivate the power saving functions of the SPC.

The smartphone provides a remote data link 140 to an external monitoring entity 139. This link may be provided by any convenient protocol. In a preferred embodiment, the remote data link is provided by the internet connection of the smartphone. This internet connection may be carried over, without limitation, wifi or the cellular data network. Where the external display and processing device is a fixed device, the internet connection may include a wired connection.

The monitoring entity may be, or may act on behalf of, an entity which has subsidised or otherwise facilitated the installation of the SPC in a householder's premises.

The SPC uses the local data link 125 and the remote data link 140 to communicate the operational data including the characteristics of the power drawn through the monitored outlets of the SPC to the monitoring entity. The operational data may include without limitation, any of the true rms power drawn by any or all of the monitored outlets, and average power drawn through any or all of the monitored outlets over time. The details of the operation of the SPC, including without limitation the timing and reason for the operation of the SPC to remove power from, or return power to, the controlled outlets, and data concerning the detection of remote control use, may be included in the operational data communicated to the monitoring entity.

The SPC is controllable to enter a simulation mode. This simulation mode allows for an estimation of the energy saved by the SPC to be made. It may also be used to verify that estimated savings continue to be made over the life of the SPC.

The command to the SPC to enter simulation mode may be user controlled using the user interface, or may come from the monitoring entity via remote data link 140 and the external display and processing device and local data link 125.

In simulation mode, the SPC functions as described previously. Data describing the power drawn through the monitored outlets is recorded and/or transmitted to the monitoring entity. Determinations that the television is or is not in use are made, both detection that the television is in a low power standby mode, and that a remote control device has not been used for a specified period. However, power to the television or other connected devices is not interrupted. The SPC monitors the sensor data indicating that the television is not in use. The SPC indicates when power would be removed from the controlled outlets were simulation mode not activated, but power is not removed. The SPC continues to monitor the energy consumption of the devices connected to the monitored controlled outlets.

The operational data describing the operation of the SPC is provided to the smartphone program via the Bluetooth link. The data is also provided to the monitoring entity via remote data link 140. This information may then be used to calculate the power consumed by the connected devices which would have been saved had the SPC operated to interrupt the power to the controlled outlets. This calculation may be performed by the smartphone program, or by the monitoring entity.

The saved power calculated is an accurate measure of the power which would have been saved by the SPC in each instance.

The calculated energy saved may be displayed to a user via the user interface where the calculations can be made in real time. Alternatively, the calculations may be made offline by the monitoring entity.

The calculated energy savings may be used by the monitoring entity to determine the actual energy savings made by the installation of the SPC.

The data or the results of the calculations may be sent to a paying entity, such as an energy utility, which supported the installation of the SPC. The monitoring entity and the paying entity may be the same entity. The actual energy savings allow the paying entity to determine whether the installation of the SPC, or a program of installation of SPCs, has achieved or is achieving the desired energy savings, and that the program and any ongoing payments are justified.

Periodic use of simulation mode allows verification of continuing energy savings over time.

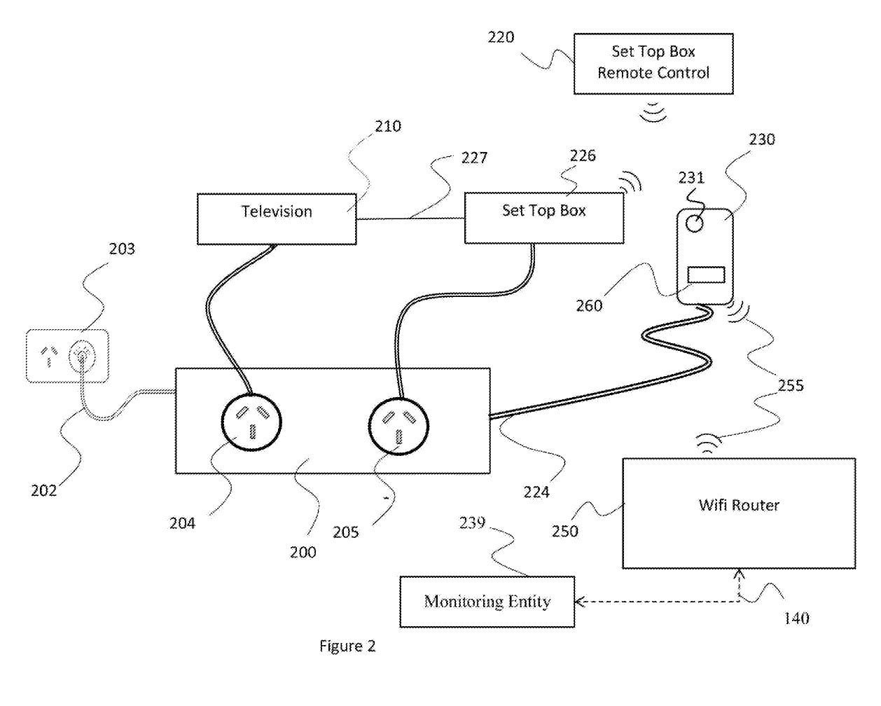

FIG. 2 shows a representation of an SPC including an embodiment of the current invention, wherein the SPC controls power supply to a television which displays a video signal from a set top box (STB). Set top box is a generic descriptor for a number of devices which perform this basic function which may be called, without limitation, such things as cable box, television decoder, satellite decoder and pay TV decoder.

The SPC 200 receives electrical power from a General Purpose Outlet 203, via power cord 202.

The SPC includes a Controlled Outlet 204 which provides electricity to a television 210. The SPC controls the flow of electricity through the Controlled Outlet and said flow may be interrupted independently of the electricity supply from the outlet 203.

There is an Always On Outlet 205, which supplies electricity at any time when electricity is supplied to the SPC from outlet 203. The Always On Outlet may be used to power any device which requires constant power. In the illustrated embodiment, the Always On Outlet 205 provides power to a set top box 226.

The set top box 226 provides a video signal to the television 210 via data connection 227. In a preferred embodiment, the data connection is an HDMI connection. Any suitable wired or wireless connection may be used.

The set top box receives a television program signal via cable, satellite or internet connection, or any other suitable connection. The set top box decodes the received program signal and displays the video on the television. Set top box is a generic descriptor for a number of devices which perform this basic function which may be called, without limitation, such things as cable box, television decoder, satellite decoder and pay TV decoder.

There is provided a set top box remote control 220. A user uses this set top box remote control to control the set top box, to select the particular television channel to be displayed on the television. Other characteristics of the video to be displayed by the television, such as the volume of the sound may also be controlled by the set top box remote control.

The set top box remote control communicates with the set top box via radio frequency (RF) signals. Any suitable protocol may be used. In a preferred embodiment, the set top box remote control communicates with the set top box using the RF4CE protocol.

The SPC includes a sensor unit 230, which includes an RF Sensor 231. The RF Sensor is able to detect the RF communication between the set top box remote control and the set top box.

The sensor unit is shown as being in a separate housing from the base unit part of the SPC which supports the outlet connections. Functionally, the sensor unit is an integral part of the SPC 200. In other embodiments, the sensor unit may be fully integrated within the base unit of the SPC. In embodiments where there are separate housings for the base unit and the sensor unit, functional circuitry including processing and memory circuitry may be divided between the housings in any convenient manner. References to an SPC herein include the sensor, whether or not housed separately.

Modern television sets and other audio visual equipment, when turned “off” by the remote control, enter a low power “standby” state, in which energy is still consumed, although at a significantly lower level that when the device is nominally “on”. When the television or other audio visual equipment is in this standby state it is not in use, and the power supply to it may be cut to save energy, without inconvenience to a user.

It is also the case that television sets may be left on for extended periods when no user is viewing the screen. This may happen when a user falls asleep in front of the television, or when a user, particularly a child or a teenager, simply leaves the vicinity of the television without turning the television off. This state may be termed “active standby”. In this state the television is not in use, and the power supply to it may be cut to save energy, without inconveniencing a user.

The SPC includes means to detect that a user is interacting with the set top box. The Sensor Unit 230 includes RF Sensor 231 which detects interaction between the set top box and the set top box remote control.

It is likely that a user, when actively watching television, will periodically use the remote control to change channels, adjust volume, mute commercials, etc. Thus a remote control signal receiver, such as RF Sensor 231 can be used as a usage sensor. If no remote control activity is detected by the RF Sensor 231 for a period of time, the assumption may be made that the television is not in use, and the power supply to the Controlled Outlet 204, and hence to the television, is interrupted. This may be achieved by using a countdown timer which starts from a specific initial value equal to a particular time period, say one hour, and having this countdown time continuously decrement. Each detected use of the remote control will reset the countdown timer to the initial value. When the countdown time reaches zero, there has been no remote control activity for the time period, and the television is assumed to not be in active use and the electricity supply to the Controlled Outlet 204, and hence to the television, is interrupted.

RF remote control devices have relatively long range and do not require line of sight between the remote control unit and the device to be controlled. This has the potential problem that a signal from a set top box remote control device may be able to be received by a device other than that for which the user intends to control. This can occur when there are multiple remote controllable devices in a household. It may also occur when dwellings are adjacent, as in an apartment block, and each dwelling has a similar set top box.

A solution to this problem which is generally implemented is for the signals emitted by the remote control, intended for a specific set top box, to include an identifier identifying either or both of the sending and intended recipient devices. The receiving device will then only act upon communications received which include either the identifier of the receiving device itself, or that of a known sending device to which the receiving device is intended to respond.

The set top box and set top box remote control are thus “paired”. This may be done at manufacture, and/or may be performed under user control.

The RF Sensor 231 is intended to respond only to signals passing between the set top box associated with the television to which the SPC is providing power, and its associated set top box remote control. This could be achieved by including the SPC in the “pairing” between the remote control and the set top box. This requires that a mechanism exist which allows the addition of a new device to the pairing arrangement. Further, the pairing process must be undertaken. This might require the SPC to have either or both of a keyboard and a display screen. In many cases, pairing is necessary to determine the commands being carried between the devices, since the operative parts of a signal, the payload, may be encrypted, and thus only accessible to paired devices.

The function of the RF Sensor is to detect the existence of a signal between the remote control and the associated set top box. To do this, it is only necessary to identify that a signal is passing between the two devices, the detail of the payload need not be known. The identity of the sending and receiving devices will be in the header of a signal between the devices rather than the encrypted payload. Since the header must be read by any device in order to decide if the message should be received, the header is not encrypted, and may be read by a device which is not in a pairing relationship with the set top box or the remote control. The SPC examines the header of any received signal to determine when the signal is from or is intended for the television. Any such communication is detected as a signal between the television and the remote control, indicating that the television is in use.

There is provided a wifi transceiver 260 which provides local data link 255 to an external communication device, in the illustrated embodiment, a household router 250. In other embodiments, without limitation, the external communication device may be a tablet computer or a desktop computer.

The wifi router 250 provides remote data link 240, which in a preferred embodiment is the internet connection of the household in which the SPC is installed, or a separately provided internet connection.

The remote data link 240 provides data access for the SPC to a monitoring entity 239. The monitoring entity may be a third party who supplied the SPC. The monitoring entity may be, or may act for, an energy utility.

The SPC is controllable to enter a simulation mode. This simulation mode allows for an accurate estimation of the energy saved by the SPC to be made. It may also be used to verify that estimated savings continue to be made over the life of the SPC.

In simulation mode, the SPC functions as described previously. Data describing the power drawn through the monitored outlets is recorded and/or transmitted to the monitoring entity. Determinations that the television is or is not in use are made, both detection that the television is in a low power standby mode, and that a remote control device has not been used for a specified period. However, power to the television or other connected devices is not interrupted. The SPC monitors the sensor data indicating that the television is not in use. The SPC indicates when power would be removed from the controlled outlets were simulation mode not activated, but power is not removed. The SPC continues to monitor the energy consumption of the devices connected to the monitored controlled outlets.

The SPC may be set into simulation mode by the monitoring entity via the remote data link. The operational data provided by the SPC is provided to the monitoring entity 239 via remote data link 240. This information may then be used to calculate the power consumed by the connected devices which would have been saved had the SPC operated to interrupt the power to the controlled outlets.

The saved power calculated is an accurate measure of the power which would have been saved by the SPC in each instance. Periodic use of simulation mode allows verification of continuing energy savings over time.

In the case where an energy utility has paid for the SPC to be installed, or pays for the continuing installation of the SPC, this allows the utility to confirm that the SPC is saving the energy which the utility expects, and that such payments are justified.

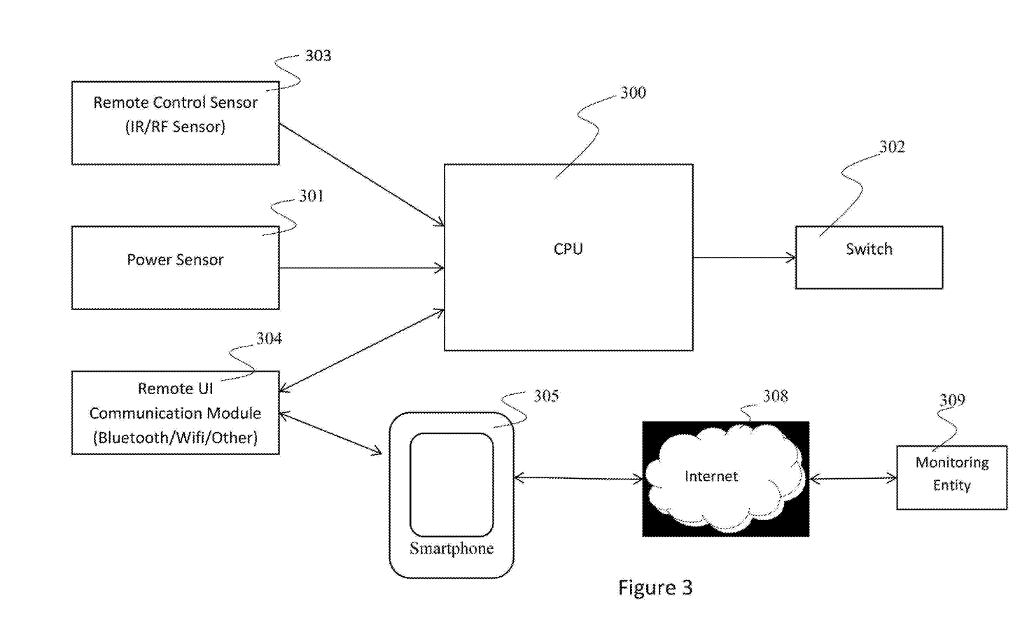

A block diagram of the functions of an embodiment of the SPC is shown in FIG. 3. In use the SPC operates to provide power to a television. A CPU 300 is provided which executes commands to provide the analytical functionality of the SPC.

There is a power sensor 301 which monitors the power drawn by the television. The power sensor may monitor the current drawn through the SPC by the television, or both current and voltage may be monitored. Phase angle may also be monitored. The output of the power sensor is provided to the CPU 300.

The monitored power draw is used by the CPU to determine the power state of the television. In an embodiment, a significant drop in the magnitude of the power draw is used to determine that a low power standby mode has been entered. Low power standby is the mode typically entered by a television when switched “off” by remote control. Most functions of the television are halted, but at least sufficient functionality remains to allow the television to be turned “on” by a remote control. Threshold values of power consumption may be used to determine the power state of the television, with any value below a threshold being determined to indicate that the television is in a low power standby power state. Other characteristics of the power use may be used to determine that the television is not in use. This may be the presence, absence or a defined pattern of, small fluctuations of the power draw.

The CPU controls one or more switches 302. When a determination is made that the television is in a standby state, the CPU controls the switch 302 in order to withdraw power from the television and, optionally, associated equipment.

There is provided a Remote control use sensor 303. In a preferred embodiment this is an infra-red (IR) sensor which detects use of infra-red remote control devices. As described in the description of FIG. 2, the Remote Control Use Sensor may be a radio frequency (RF) detector, which detects RF traffic between a device, which may be a television or a set top box, or another piece of AV equipment, and a remote control.

The CPU receives data from the Remote control use sensor 303 indicating use of a remote control.

The CPU determines when no remote control use activity has been detected for a predetermined period. When this occurs, the CPU flashes the warning LED or provides another warning that the television is about to be shut down. If no remote control activity is detected in response to the warning, the power to the television is interrupted.

While power to the television is interrupted, the remote control use sensor continues to monitor remote control activity, and send the results to the CPU. When the CPU determines that remote control activity has been detected, the switch 302 is operated and thus power is restored to the television.

In a preferred embodiment, when the power to the television is in the interrupted state, the SPC will return power to the television when any remote control activity is detected. In an alternative embodiment, the SPC may require that the received remote control signal is identified as an “ON” command for the television before returning power to the television. This reduces “false positives” where the SPC reacts to an IR or RF source which is other than the user attempting to turn the television on.

The CPU may be programmed to keep track of the power consumption of the monitored load, both when the load is using full power and when it is in a low power standby state. Information concerning the number of times the power to the load is interrupted may be recorded. Whether the power was interrupted because the television was in a low power standby mode, or because the television was determined to not be in use may also be recorded. This operational data may be used to calculate or estimate the energy savings achieved by the SPC.

The SPC includes a Remote User Interface Communication Module 304. In a preferred embodiment, this is a Bluetooth communication module. In alternative embodiments, without limitation, this may be a wifi module. The Bluetooth communication module 304 is in data communication with a Remote User Interface Display 305. This is a processing and display device, capable of running a user interface program which is adapted to display and operate a user interface for the SPC. In a preferred embodiment, this is a smartphone. Alternatively, without limitation, the processing and display device may be a tablet computer, a laptop computer or a desktop computer. A dedicated display device may also be provided.

The user interface may be used to control the SPC. The value of the predetermined period which must elapse before the SPC concludes that the television is not in use may be changed temporarily or permanently. That is, the threshold time of no detection of IR signals before the SPC decides that the television is in Active Standby may be varied from the user interface.

The Remote User Interface Display 305 provides a remote data link, via the internet 308 to a monitoring entity 309.

The SPC communicates the raw data from the power sensor and the IR sensor, along with the timing of the switch control activity, to the smartphone, for communication via the internet 308 to the monitoring entity.

The monitoring entity may then use this data to estimate energy savings which are attributable to the installation of the SPC.

Alternatively, these calculations may be undertaken by the user interface program. The user interface program may process the data for display to the user in any convenient manner. This data and the results of analysis may be communicated by the smartphone, to the monitoring entity.

The user interface may be used to control the SPC to enter simulation mode via the Bluetooth communication module. The instruction to enter simulation mode may come from a local user using the smartphone, or from the monitoring entity via the internet 308.

In simulation mode, the SPC functions as described previously. However, the switch or switches 302 are not operated. The SPC records when the output of power sensor indicates that the television has entered a low power standby mode, without operating the switch.

The SPC also records when a determination has been made that the television is in active standby, but again, the switch is not operated.

Thus the television continues to operate and to use energy. The SPC continues to record the energy consumption of the devices connected to the controlled outlets including the television. The operational data consisting of the data describing when the switches 302 would have been operated were simulation mode not active, and the power consumption data recorded by the SPC is transmitted to the monitoring entity.

This operational data may then be used to calculate the power consumed by the connected devices which would have been saved had the SPC operated to interrupt the power to the controlled outlets.

The saved power calculated is an accurate measure of the power which would have been saved by the SPC in each instance. Periodic use of simulation mode allows verification of continuing energy savings over time.

In the case where an energy utility has paid for the SPC to be installed, or pays for the continuing installation of the SPC, this allows the utility to confirm that the SPC is saving the energy which the utility expects, and that such payments are justified.

A major cause of failure by SPCs to save power is de-installation when a user finds the action of the SPC intrusive or annoying and simply removes the SPC, preventing any energy saving. False detection of Active Standby and subsequent cutting of power to the television which is in use is a major cause of this failure.

The SPC may also report to the user interface program, the frequency of use of the IR remote control. The user interface program may also collect information on how often and at what times the user uses the remote control to prevent the SPC removing power from the television after a warning has been given. These are occasions when the SPC has determined incorrectly that the television is in Active Standby when a user is still actively watching the television. This information may be used to determine a more accurate pattern which indicates that the television is in fact in Active Standby, allowing less occasions where the SPC attempts to or does cut power to a television in active use. Improvements in the determination of Active Standby reduce de-installation.

The user interface may present information about the use of IR and correct and incorrect determination of Active Standby. Where this information shows that incorrect determinations are rare, user satisfaction with the SPC is likely to be improved, leading to lower de-installation rates.

Where threshold values of power consumption are used, these may be changed by a user from the user interface on the smartphone.

In an embodiment where the warning mechanism is controllable, the user interface on the smartphone may allow control of, without limitation, the brightness of a warning LED, the volume of an audible warning, the times when the flashing LED, the audible warning, and no warning should be used.

The user interface allows information collected by the SPC to be displayed to a user. In an embodiment where the SPC monitors the voltage and/or frequency of the incoming electricity supply, this information may be displayed to a user. Any parameters of the incoming electricity supply monitored by the SPC may be reported to the user interface program. These may be compared with pre-set values, for example, the limits set for these parameters by a regulator, to report on the performance and quality of the incoming electricity supply.

The user interface may allow the user to control the switch in the SPC directly, turning the switched outlets on and off independently of the determined power and usage state of the television.

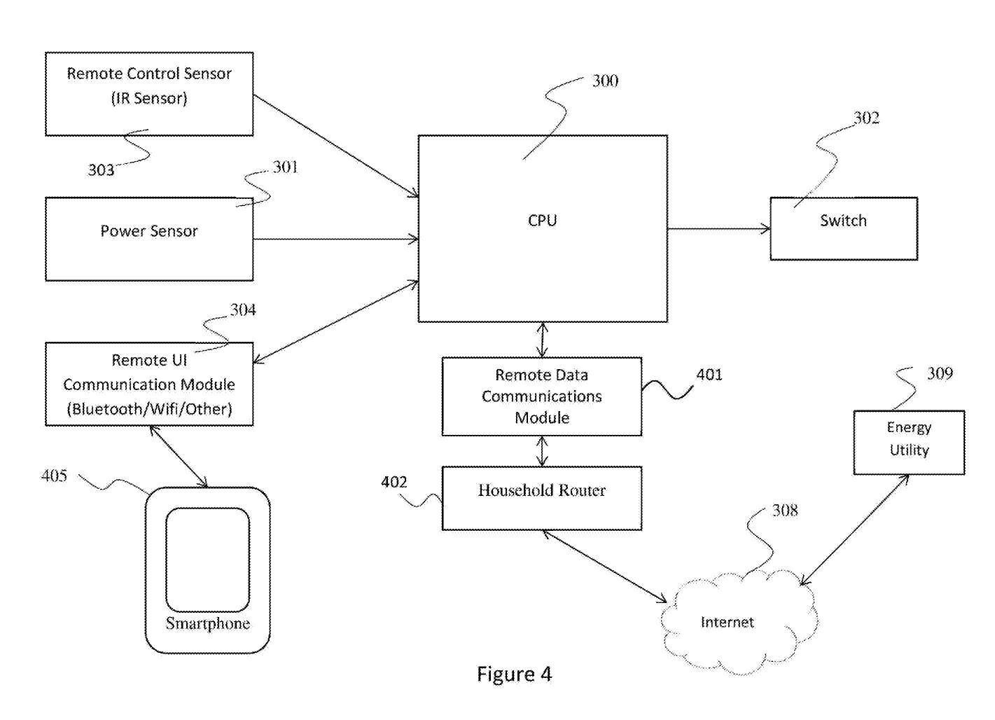

FIG. 4 is a block diagram of a further embodiment of the invention. Elements having the same reference numbers as appearing on FIG. 3 have the same function.

The SPC includes a Remote User Interface Communication Module 304. In a preferred embodiment, this is a Bluetooth communication module. In alternative embodiments, without limitation, this may be a wifi module. The Bluetooth communication module 304 is in data communication with a Remote User Interface Display 405. This is a processing and display device, capable of running a user interface program which is adapted to display and operate a user interface for the SPC. In a preferred embodiment, this is a smartphone. Alternatively, without limitation, the processing and display device may be a tablet computer, a laptop computer or a desktop computer. A dedicated display device may also be provided.

The user interface may be used to control the SPC. The value of the predetermined period which must elapse before the SPC concludes that the television is not in use may be changed temporarily or permanently. That is, the threshold time of no detection of IR signals before the SPC decides that the television is in Active Standby may be varied from the user interface.

All functions of the user interface program of FIG. 3 which do not require internet access may be undertaken by the user interface program running on the smartphone 405.

The SPC includes a Remote Data Communications Module 401. In the illustrated embodiment, this is a wifi module. In other embodiments, any suitable wireless communication protocol may be used. The Remote Data Communications Module 401 provides a remote data link from the SPC to a household router 402. This is a router which provides internet access for the household in which the SPC is installed.

The router 402 provides data access, via the internet 308 to the external monitoring entity 309.

The SPC communicates the raw data from the power sensor 301 and the remote control use sensor 303, along with the timing of the switch control activity, to the monitoring entity, via the Remote Data Communications Module 401 and the internet 308.

The monitoring entity may then use this data to estimate energy savings which are attributable to the installation of the SPC.

The user interface may be used to control the SPC to enter simulation mode via the Bluetooth communication module. The instruction to enter simulation mode may come from a local user using the smartphone, or from the monitoring entity via the internet 308.

In simulation mode, the SPC functions as described previously. However, the switch or switches 302 are not operated. The SPC records when the output of power sensor indicates that the television has entered a low power standby mode, without operating the switch.

The SPC also records when a determination has been made that the television is in active standby, but again, the switch is not operated.

Thus the television continues to operate and to use energy. The SPC continues to record the energy consumption of the devices connected to the controlled outlets including the television. The operational data consisting of the data describing when the switches 302 would have been operated were simulation mode not active, and the power consumption data recorded by the SPC is transmitted to the monitoring entity via Remote Data Communications Module 401 and the internet 308.

This operational data may then be used to calculate the power consumed by the connected devices which would have been saved had the SPC operated to interrupt the power to the controlled outlets.

The saved power calculated is an accurate measure of the power which would have been saved by the SPC in each instance. Periodic use of simulation mode allows verification of continuing energy savings over time.

In the case where an energy utility has paid for the SPC to be installed, or pays for the continuing installation of the SPC, this allows the utility to confirm that the SPC is saving the energy which the utility expects, and that such payments are justified.

A major cause of failure by SPCs to save power is de-installation when a user finds the action of the SPC intrusive or annoying and simply removes the SPC, preventing any energy saving. False detection of Active Standby and subsequent cutting of power to the television which is in use is a major cause of this failure.

The SPC may also report to the monitoring entity, the frequency of use of the television remote control. The monitoring entity may also collect information on how often and at what times the user uses the remote control to prevent the SPC removing power from the television after a warning has been given. These are occasions when the SPC has determined incorrectly that the television is in Active Standby when a user is still actively watching the television. This information may be used to determine a more accurate pattern which indicates that the television is in fact in Active Standby, allowing less occasions where the SPC attempts to or does cut power to a television in active use. Improvements in the determination of Active Standby reduce de-installation. Where this information shows that incorrect determinations are rare, user satisfaction with the SPC is likely to be improved, leading to lower de-installation rates.

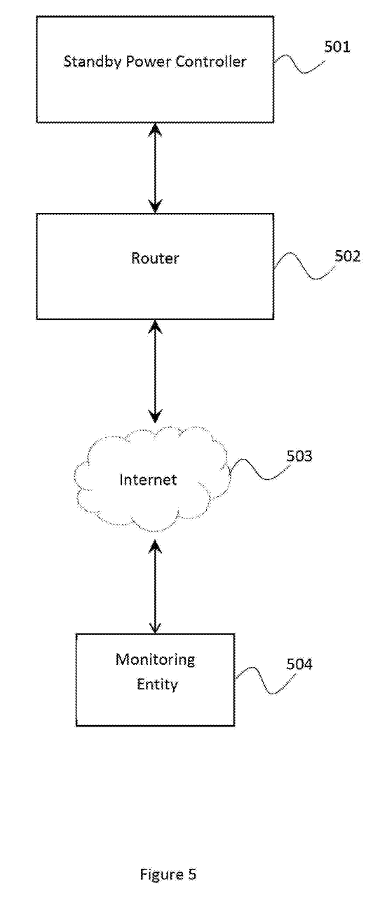

FIG. 5 is a block diagram of the major elements of an embodiment of the invention.

There is a standby power controller, which is in data communication with an internet router 502. The router provides access to the internet 503. An internet connection is established from the standby power controller 501 to an external monitoring entity 504.

The standby power controller is a device which saves energy by switching offa supply of electricity to electrical devices when a television is determined to in an Active Standby or Low Power Standby state.

The external monitoring entity may be any entity with an interest in the installation and operation of the SPC. The monitoring entity may be or may act on behalf of an electrical utility concerned with the supply of electricity to the premises where the PC is installed.

The data communication link between the SPC and the router may be any suitable protocol. In a preferred embodiment, this is a wifi link.

The router may be replaced with any suitable device able to provide internet access.

The SPC includes a sensor or sensors which sense the power drawn through the SPC by connected electrical devices. The output of these sensors is power data, describing the power use of the connected electrical devices. The SPC may control or monitor power drawn by multiple devices. The power data may relate to one or more devices and may be aggregated across more than one device, or may include individual information for any or each of the connected electrical devices.

The SPC determines a switch state to set a switch to switch off or switch on said supply of electricity. The SPC produces operational data which describes the operation of the SPC including the power data and the switch state.

Where the SPC determines that a television is in Active Standby, the output of the sensor used to make said determination is included in the operational data.

The operational data is transmitted by the SPC to the monitoring entity. The monitoring entity may use the operational data for any purpose relating to the monitoring of of the operation of the SPC. This may include without limitation: to determine that the SPC remains installed; to estimate the energy savings made by the installation of the device; to determine the degree to which the operation of the SPC includes incorrect determination of a standby mode; to determine whether a payment should be made related to the installation or continued installation of the SPPC; and to determine the success of a program of subsidised installation of numbers of SPC devices.

In further embodiments the operational data may be transmitted from the SPC to the monitoring entity by any convenient data transport technology and protocol. This may include, without limitation, mesh networks, direct communication between the SPC and the monitoring entity via a cellular data network, an LTE-M network and a LPWA network.

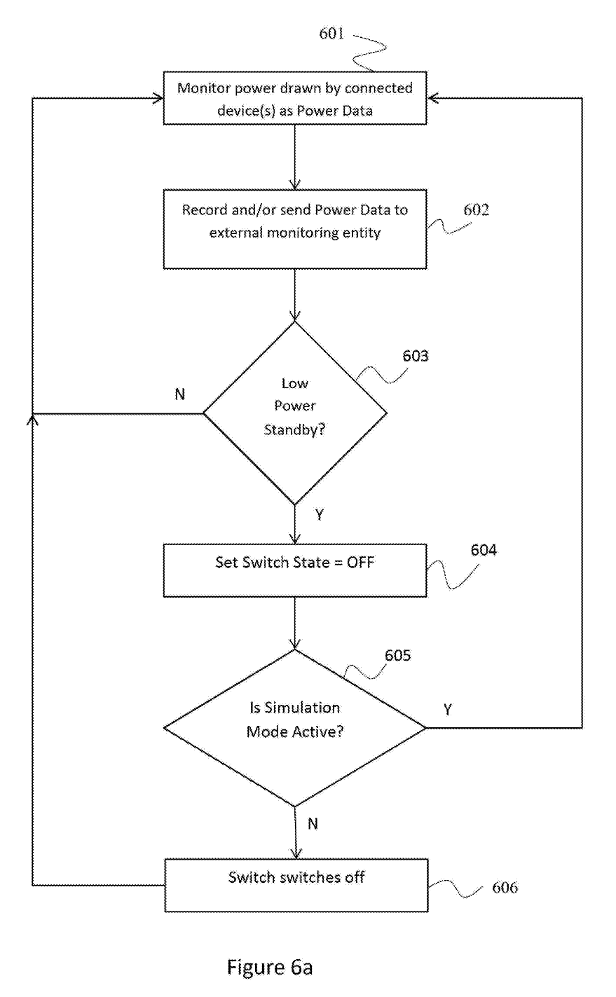

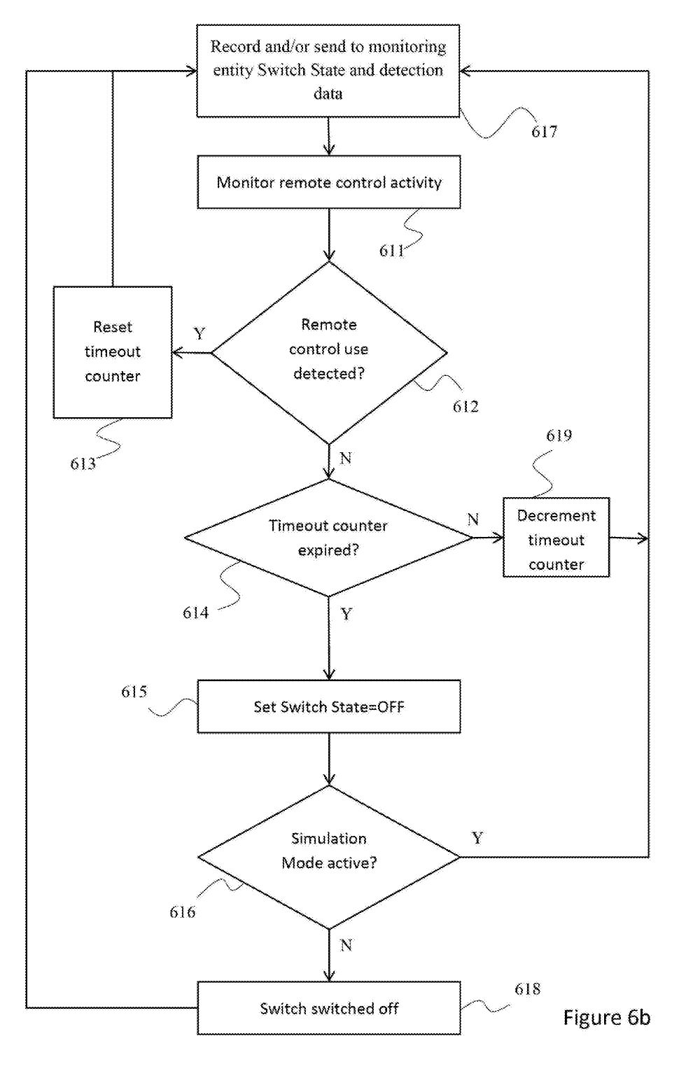

FIG. 6 shows flowcharts of the operation of detection of low power standby and Active Standby in any embodiment described herein of an SPC including the invention where the SPC includes a simulation mode able to be field activated.

Referring to FIG. 6a, in use the SPC monitors 601 power data, being the power drawn by devices connected to the monitored outlets of the SPC.

The monitored power data is stored by the SPC, or transmitted to the external monitoring entity, or both at step 602. Storage may be locally within memory provided within the SPC, or by a user interface program running on a separate processing device. Data transmission may use any convenient data link technology and protocol, or combination of technologies and protocols, including, without limitation, wifi, Bluetooth or an internet connection.

The SPC determines, at step 603, whether the devices connected to the monitored outlets are in a low power standby state. Threshold values of power consumption may be used to determine the power state of the television, with any value below a threshold being determined to indicate that the television is in a low power standby power state. Other characteristics of the power use may be used to determine that the television is not in use. This may be the presence, absence or a defined pattern of, small fluctuations of the power draw.

Where a determination is made that the television is not in a low power standby state, the SPC continues to monitor 602 the power drawn by the connected devices.

Where it is determined that the television is in a low power standby state, the SPC may save energy by operating a switch to remove the supply of electrical power from the controlled outlets and hence the devices connected to those outlets.

In order to operate the switch, the firmware of the SPC provides a command to operate the switch. In an embodiment this is the setting of a flag Switch State to a value indicating that the switch should be ON, indicating that power will flow to the controlled outlets, or the switch should be OFF, indicating that the flow of power to the controlled outlets is to be interrupted. In other embodiments, other methods of controlling the switch may be used. Data indicating the determined switch state will be available.

Having determined 603 that the switch should be off, the SPC sets 604 the flag Switch State to OFF.

The SPC includes functionality allowing a simulation mode to be set. Simulation mode may be set by any convenient means, including, without limitation, a physical switch incorporated in the SPC, via a user interface, or remotely via a data link from the monitoring entity.

The SPC then checks, 605 whether simulation mode has been set. Where simulation mode is active, the SPC continues 601 to monitor power drawn through the SPC.

Where simulation mode is determined not to be active, the SPC proceeds to switch the switch or switches off 606, withdrawing the power supply to the controlled outlets and the connected devices, in order to save energy.

It can be seen that in simulation mode, the SPC continues to monitor power data 601 and to record and/or transmit Power Data to the external monitoring entity, without switching off the power supply to the controlled outlets.

Referring to FIG. 6b, the SPC monitors a television powered from a monitored outlet of the SPC to determine if the television is in Active Standby. The SPC monitors 611 remote control activity. The SPC may monitor for, without limitation, any or all of use a remote control associated with a television; use of a remote control associated with a set top box displaying a video signal via a television and use of a remote control associated with any other audio visual device powered via a controlled outlet of the SPC.

Active Standby is detected when no use of a remote control has been detected for a selected period of time, being the timeout time.

The SPC determines 612 whether remote control use has been detected. The SPC maintains a timeout counter to determine a time period since remote control activity was last detected.

Where remote control use is detected, the SPC, at step 613, resets this timeout value to a maximum value.

The SPC records and/or sends to a remote monitoring entity 617 data describing the remote control detection, along with the Switch State.

The SPC then continues 611 to monitor for remote control activity.

Where no remote control use is detected, the SPC then checks 614 whether the timeout counter has expired. Where the timeout counter has not expired, the timeout counter is decremented 619. The SPC records and/or sends to a remote monitoring entity 617 data describing the remote control detection, along with the Switch State. The SPC then continues 611 to monitor for remote control activity.

When the timeout counter is determined to be exceeded, remote control use has not been detected for the selected period, and the television is in Active Standby. The SPC may save energy by operating a switch to remove the supply of electrical power from the controlled outlets and hence the devices connected to those outlets.

In order to operate the switch, the firmware of the SPC provides a command to operate the switch. In an embodiment this is the setting of a flag Switch State to a value indicating that the switch should be ON, indicating that power will flow to the controlled outlets, or the switch should be OFF, indicating that the flow of power to the controlled outlets is to be interrupted. In other embodiments, other methods of controlling the switch may be used. Data indicating the determined switch state will be available.

Having determined 614 that the switch should be off, the SPC sets 615 the flag Switch State to OFF.

The SPC includes functionality allowing a simulation mode to be set. Simulation mode may be set by any convenient means, including, without limitation, a physical switch incorporated in the SPC, via a user interface, or remotely via a data link from the monitoring entity.

The SPC then checks, 616 whether simulation mode has been set. Where simulation mode is active, the SPC records and/or sends to a remote monitoring entity 617 data describing the remote control detection, along with the Switch State. The SPC then continues 611 to monitor for remote control activity.

Where simulation mode is determined not to be active, the SPC proceeds to switch the switch or switches off 618, withdrawing the power supply to the controlled outlets and the connected devices, in order to save energy.

It can be seen that in simulation mode, the SPC continues to monitor remote control activity 611 and to record and/or transmit 617 the Switch State and data describing the detection of remote control activity to the external monitoring entity, without switching off the power supply to the controlled outlets.

The Power Data and the Switch State together constitute part or all of the operational data communicated by an SPC to a remote monitoring entity. The recording and/or sending steps 602 and 617 may be the same operation, with all operation data being stored or sent to the monitoring entity in the same operation.

The remote monitoring entity receives data when the SPC is in simulation mode which allows the calculation, with good accuracy, of the energy savings which would have been made had the SPC not been in simulation mode, and the switch or switches had been turned OFF to cut power to the controlled outlets.

The energy savings which can be attributed to the installation of an SPC are often estimated using so-called pre and post trials. In such trials, the energy use of the devices which will be connected to the controlled outlets of the SPC is measured over a period of time. This is the “pre” or pre-installation part of the trial. The SPC is then installed. The power use of the same devices is then measured over the same period of time. This is the “post” or post-installation phase of the trial. The difference between the pre and post installation energy use is the estimated energy saved by the installation.

The estimate of energy saved is only valid if the devices were used in substantially the same way in the pre and post phases. In a domestic household situation this is very often not the case. This means that such estimates of power saving are often very inaccurate.

Trials which use an SPC using simulation mode, allow accurate determination of the power which is saved by the SPC installation. Since the devices connected to the controlled outlets continue to use power after the SPC has determined that it would have switched off the power were simulation mode not active, and that power use is measured, it is known accurately what power would not have been used had the SPC been in an ordinary operation mode rather than simulation mode. It is also possible to determine the amount of power saving which may be attributed to the avoidance of energy wastage in Active Standby and to the avoidance of energy wastage in low power standby, in a single trial. This is because the detection data is available to the monitoring entity, allowing determination of the reason that the Switch State was changed on each occasion. Where the length of a trial is relevant, a trial using simulation mode can collect data in half the time of that required for a pre and post style trial.

Where reference has been made to infra-red remote controls and corresponding infra-red sensors, it will be understood that any form of remote control and corresponding sensors, including, without limitation, radio frequency remote controls, may be employed.

Where reference has been made to Bluetooth as the communication mode between the SPC and the smartphone, any suitable wired or wireless communications means or protocol may be used. The external processing and communication device, where disclosed as a smartphone, may be provided by any suitable processing device including without limitation, a tablet computer, a desktop computer, an internet router and a dedicated processing device.

Although the invention has been herein shown and described in what is conceived to be the most practical and preferred embodiments, it is recognised that departures can be made within the scope of the invention, which is not to be limited to the details described herein but is to be accorded the full scope of the disclosure so as to embrace any and all equivalent devices and apparatus.

1-19. (canceled)

20. A standby power controller including:
a. a power sensor configured to sense power drawn through the standby power controller,
b. a remote control sensor configured to sense use of a remote control device,
c. a processor configured to:
(1) determine from the output of the power sensor that devices connected to the standby power controller are in a low power standby power state,
(2) determine from the output of the remote control sensor that a television connected to the standby power controller is in an active standby state,
(3) sets a switch state to an on state or an off state, wherein:
i. the off state is set when the low power standby state or the active standby state is determined, and
ii. the off state operates a switch to remove power from the television,
d. a remote data link providing data communication between the standby power controller and a remote monitoring entity.

21. The standby power controller of claim 20 wherein the processor:
a. receives the output of the power sensor, and
b. communicates the output of the power sensor to the monitoring entity.

22. The standby power controller of claim 20 wherein the processor:
a. receives the output of the remote control sensor,
b. determines from the output of the remote control sensor that a remote control device has been operated, and
c. communicates the result of the determination to the monitoring entity.

23. The standby power controller of claim 20 wherein the processor:
a. receives the output of the remote control sensor, and
b. communicates the output of the remote control sensor to the monitoring entity.

24. The standby controller of claim 20 wherein the processor communicates the switch state to the monitoring entity.

25. The standby power controller of claim 20 wherein the standby power controller is configured to enter a simulation mode wherein the setting of the switch state does not cause operation of the switch.

26. The standby power controller of claim 25 wherein the simulation mode may be activated by a command from the monitoring entity.

27. The standby power controller of claim 25 wherein simulation mode may be activated by operation of a simulation mode switch integrated into the standby power controller.

28. The standby power controller of claim 25 in combination with a processing device in wireless communication with the standby power controller, the processing device:
a. having a display, and
b. having a user interface controlling at least one function of the standby power controller.

29. The standby power controller of claim 28 wherein the processing device is one of:
a. a smartphone,
b. a tablet computer,
c. a desktop computer, and
d. a dedicated display device.

30. The standby power controller of claim 28 wherein the user interface commands the standby power controller to enter the simulation mode.

31. The standby power controller of claim 20 wherein the remote data link includes a connection between the standby power controller and a smartphone.

32. The standby power controller of claim 20 wherein the remote data link includes a connection between the standby power controller and an internet router.

33. A method for monitoring the operation of the standby power controller of claim 20, the method including the steps of:
a. installing the standby power controller in a household,
b. the standby power controller:
(1) establishing the remote data link with the remote monitoring entity,
(2) obtaining power data via the power sensor, the power data being the power drawn through the standby power controller by connected devices,
(3) communicating the power data to the remote monitoring entity.

34. The method of claim 33 further including the steps of the standby power controller:
a. analyzing the power data to determine that a television connected to the standby power controller is in a low power standby state,
b. removing power from the television upon determining that the television connected to the standby power controller is in a low power standby state,
c. communicating the determination to the remote monitoring entity.

35. The method of claim 33 further including the steps of the standby power controller:
a. monitoring for use of a remote control device via the remote control sensor,
b. when use of a remote control device is not detected for a selected time period, determining that a television connected to the standby power controller is in an active standby state,
c. upon determining that the television connected to the standby power controller is in an active standby state:
(1) removing power from the television, and
(2) communicating the determination to the remote monitoring entity.

36. The method of claim 33 wherein the step of establishing the remote data link with the remote monitoring entity includes accessing an internet router via wifi.

37. A method for estimating the power savings attributed to an installation of the standby power controller of claim 20,
a. wherein the standby power controller is configured to enter a simulation mode wherein the setting of the switch state does not cause operation of the switch,
b. the method including the steps of the standby power controller:
(1) establishing the remote data link with the remote monitoring entity,
(2) entering the simulation mode,
(3) obtaining power data via the power sensor, the power data being the power drawn through the standby power controller by connected devices,
(4) analyzing the power data to determine that a television connected to the standby power controller is in a low power standby state,
(5) following the determination:
i. communicating the determination to the remote monitoring entity,
ii. continuing to obtain power data,
iii. communicating the power data to the remote monitoring entity,
c. the remote monitoring entity determining the energy savings attributable to the installation of the standby power controller, the energy savings being dependent on energy the power data indicates is consumed while the television is in the low power standby state.

38. The method of claim 37 further including the steps of:
a. monitoring for use of a remote control device via the remote control sensor,
b. when use of the remote control device is not detected for a selected time period, determining that a television connected to the standby power controller is in an active standby state,
c. following the determination:
(1) communicating the determination to the remote monitoring entity,
(2) continuing to:
i. obtain power data, and
ii. monitor for use of the remote control device,
(3) communicating the power data to the remote monitoring entity while the television is determined to be in the active standby state,
d. the remote monitoring entity determining the energy savings attributable to the installation of the standby power controller, the energy savings being dependent on:
(1) energy the power data indicates is consumed while the television is in a low power standby state, and
(2) energy the power data indicates is consumed while the television is in an active standby state.
